(19) United States
(12) Patent Application Publication
(10) Pub. No.: US 2011/0106613 A1
(43) Pub. Date: May 5, 2011

(54) ELECTRONIC COUPON DISTRIBUTION, COLLECTION, AND UTILIZATION SYSTEMS AND METHODS

(75) Inventors: Michelle Felt, Randolph, NJ (US); Nader Gharachorloo, Ossining, NY (US); Jianxiu J. Hao, Lexington, MA (US); Farida Saeed, Boonton, NJ (US)

(73) Assignee: VERIZON PATENT AND LICENSING, INC., Basking Ridge, NJ (US)

(21) Appl. No.: 12/611,613

(22) Filed: Nov. 3, 2009

(51) Int. Cl. G06Q 30/00; G01C 21/00; G06Q 10/00

(52) U.S. Cl. 705/14.46; 705/14.1; 701/201; 705/14.25

(57) ABSTRACT

Exemplary electronic coupon distribution, collection, and utilization systems and methods are disclosed. An exemplary method includes maintaining coupon data representative of at least one electronic coupon collected by a consumer, the coupon data accessible by a mobile computing device associated with the consumer, detecting an occurrence of a predetermined trigger event related to the at least one electronic coupon, and providing, in response to the predetermined trigger event, a message for presentation to the consumer via the mobile computing device associated with the consumer, the message configured to direct the consumer to a physical location of a product associated with the at least one electronic coupon. Corresponding systems and methods are also disclosed.

### BACKGROUND INFORMATION

A strategy commonly used to market products or services is to issue coupons offering discount prices for the products or services. Traditionally, coupons are printed and distributed through channels such as newspapers, direct mail, or other print media. Electronic coupons are also distributed through electronic channels such as electronic mail, text messaging, and the Internet.

However, typically only a very small percentage of the coupons distributed through traditional channels are actually redeemed. This inefficiency may be due at least in part to the traditional and fragmented process consumers must perform to redeem coupons. In particular, in fragmented steps, consumers must clip or print, store, recall, tote, and redeem coupons distributed through traditional channels. It is typically a time-consuming process for a consumer to sort through coupons distributed via traditional channels to find coupons that are relevant or of value to the consumer. Subsequently, the consumer must remember to tote and redeem the coupons when shopping. Even when the consumer remembers to bring and use the coupons when shopping, it can be difficult or time consuming for the consumer to locate products associated with the coupons, especially in large stores such as supermarkets and big-box retail warehouses.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary electronic coupon distribution, collection, and utilization system.

FIG. 2 illustrates an exemplary implementation of the system of FIG. 1.

FIG. 3 illustrates exemplary components of an electronic coupon subsystem.

FIG. 4 illustrates an exemplary electronic coupon processing device.

FIG. 5 illustrates an exemplary electronic coupon distribution method.

FIG. 6 illustrates an exemplary coupon distribution settings setup view displayed in a graphical user interface.

FIG. 7 illustrates an exemplary electronic coupon distribution method.

FIG. 8 illustrates an exemplary electronic coupon collection method.

FIG. 9 illustrates an exemplary coupon processing options view displayed in a graphical user interface.

FIG. 10 illustrates an exemplary electronic coupon utilization method.

FIGS. 11-12 illustrate exemplary graphical user interfaces displayed on a display screen of a mobile phone device.

FIG. 13 illustrates an exemplary store premises map.

### DETAILED DESCRIPTION OF PREFERRED EMBODIMENTS

Exemplary electronic coupon distribution, collection, and utilization systems and methods are described herein. The exemplary systems and methods may provide targeted distribution of electronic coupons and/or advertisements, improved rates of return for marketers, increased value for consumers, improved convenience in discovering, collecting, and utilizing relevant electronic coupons, and/or improved convenience in finding products associated with electronic coupons.

As used herein, the term “coupon” may refer generally to any offer, discount, deal, or promotion associated with a product or service. Typically, a coupon provides a discount of some sort to a consumer who uses the coupon in association with a purchase of a product or service. The term “electronic coupon” as used herein may refer to electronic data representative of a coupon.

As used herein, the term “consumer” may refer generally to any individual or organization that purchases or may potentially purchase or otherwise consume products and/or services. The term “marketer” as used herein may refer generally to any individual or organization that sells, markets, advertises, manufactures, distributes, or otherwise provides or promotes products and/or services for consumption and/or for further distribution. The term “product” as used hereinafter may refer generally to any product or service that may be consumed, purchased, or otherwise used by a consumer.

Exemplary embodiments of electronic coupon distribution, collection, and utilization systems and methods will now be described in more detail with reference to the accompanying drawings.

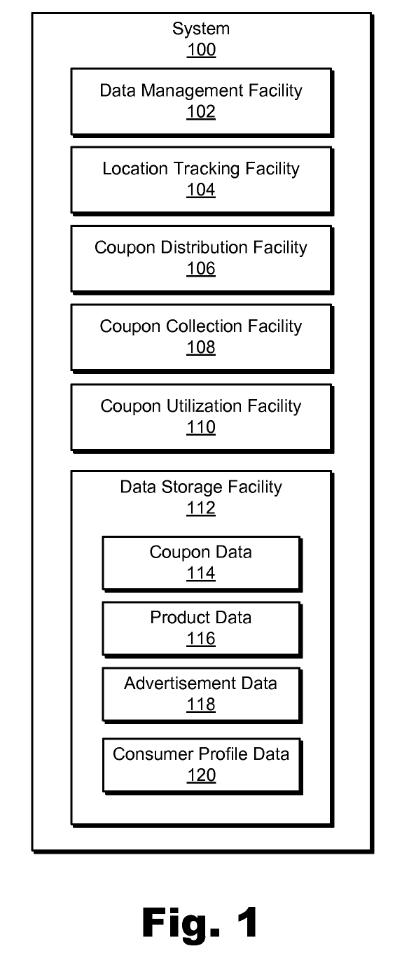

FIG. 1 illustrates an exemplary electronic coupon distribution, collection, and utilization system 100 (or simply “system 100”). While an exemplary system 100 is shown in FIG. 1, the components and configuration of system 100 illustrated in FIG. 1 are not intended to be limiting. Additional or alternative components and/or configurations may be used in other embodiments. In certain alternative embodiments, for example, one or more of the components shown in FIG. 1 may be omitted or combined.

System 100 may include, but is not limited to, a data management facility 102, a location tracking facility 104, a coupon distribution facility 106, a coupon collection facility 108, a coupon utilization facility 110, and a data storage facility 112 selectively and communicatively coupled one to another. Any suitable communication technologies, including any of the communication technologies mentioned herein, may be employed to facilitate communications between facilities 102-112.

Data management facility 102 may be configured to receive, store, aggregate, organize, maintain, and otherwise manage data, including coupon data 114, product data 116, advertisement data 118, and profile data 120. Coupon data 114 may include any data representative of, descriptive of, or otherwise associated with one or more electronic coupons. In certain embodiments, coupon data 114 may include, without limitation, data representative of coupon identifiers, product identifiers for products associated with the coupons, coupon expiration dates, coupon redemption terms, coupon values, and coupon redemption sites (e.g., store names and/or locations where the coupons may be redeemed). Product data 116 may include any data representative of, descriptive of, or otherwise associated with one or more products. In certain embodiments, product data 116 may include, without limitation, data representative of product identifiers (e.g., barcodes), product descriptions, product attributes, and locations of the products (e.g., store names, store addresses, maps of store layouts, physical locations of products such as geographic coordinates of product locations, etc.). Advertisement data 118 may include any data representative of promotional or informational content for one or more products. In certain embodiments, advertisement data 118 may include, without limitation, data representative of informational and/or advertisement audio, image, and/or video content. Profile data 120 may include any data representative of profiles and/or preferences of users (e.g., consumers and/or marketers) accessing system 100. In certain embodiments, profile data 120 may include, without limitation, data representative of one or more consumer profiles, marketer profiles, user and/or device identifiers (e.g., mobile phone numbers), relationships between coupons and user profiles (e.g., data identifying coupons collected by a consumer), relationships between products and user profiles (e.g., data identifying products, product categories, and/or product brands identified as being of interest and/or not of interest to the consumer), a location navigation history for a mobile computing device associated with a consumer, a purchase history of a consumer, and/or any other information related to a consumer.

As described in more detail further below, data management facility 102 may be configured to receive coupon data 114, product data 116, and/or advertisement data 118 from one or more marketers and/or access devices associated with marketers. Hence, a marketer may provide coupon data 114 representing one or more electronic coupons, product data 116 related to one or more products, and/or advertising data 118 related to the products. As an example, a marketer may upload an electronic coupon to data management facility 102. In addition, the marketer may provide product data 116 such as information indicating one or more physical locations at which a product is available for pickup and/or purchase. As described further below, this data received from the marketer may be used by system 100 to distribute the electronic coupon to a consumer in a targeted manner. The data received from the marketer may be further used to promote collection and utilization of the coupon by the consumer, such as by reminding a consumer of a collected electronic coupon associated with a product. Data received from one or more marketers may be aggregated and stored by data management facility 102 in data storage facility 112.

Location tracking facility 104 may be configured to track a geographic location of a mobile computing device associated with a consumer. The tracking of the geographic location of the mobile computing device may be performed in any suitable way and using any suitable technologies, including, without limitation, Global Positioning System (“GPS”) technologies and terrestrial signaling triangulation technologies. As an example, the mobile computing device may comprise a mobile phone device, the location of which may be tracked using GPS and/or cellular phone wireless signaling triangulation technologies. In certain embodiments, location tracking facility 104 may track the geographic location of the mobile computing device within a particular geographic space (e.g., within a store premises). One or more wireless signal transmitters may be employed to boost reception of location tracking signals within a building premises.

Location tracking facility 104 may be further configured to generate a navigation history for a consumer based on the tracked geographic location of a mobile computing device associated with the consumer. The navigation history may be generated in any suitable way such as by aggregating data points obtained from tracking the geographic location of the mobile computing device. In certain examples, the navigation history may be specific to a particular geographic space. For instance, the navigation history may comprise a store navigation history including a record of locations of a mobile computing device within a store premises. Such a store navigation history may be used to identify habits and/or preferences of a consumer within the store premises. A store navigation history may include, without limitation, data indicative of consumer shopping patterns (e.g., preferred day-of-week, time-of-day, and/or seasonal shopping patterns), durations of time spent by a consumer within the store premises, and durations of time spent by the consumer in one or more particular sections within the store premises (e.g., in a particular aisle or product section). As described further below, data representative of a tracked geographic location of a mobile computing device and/or a navigation history for a consumer may be utilized in association with distribution, collection, and/or utilization of electronic coupons. Additionally or alternatively, in certain examples, system 100 may be configured to provide navigation history data for one or more consumers to a marketer, who may utilize the navigation history data such as by adjusting a store layout and/or product layout within a store based on the navigation history data.

Coupon distribution facility 106 may be configured to distribute electronic coupons maintained in data storage facility 112 in a targeted manner to one or more consumers and/or access devices associated with consumers. To this end, coupon distribution facility 106 may be configured to distribute electronic coupons in response to one or more predetermined coupon distribution trigger events, which may include any event or set of events defined for detection by coupon distribution facility 106. As an example, a predetermined trigger event may include a receipt of an express consumer request for one or more electronic coupons. In response to the consumer request, coupon distribution facility 106 may provide the requested electronic coupons to the consumer. As another example, a predetermined trigger event may include a detection that a mobile computing device is located within a predetermined geographic proximity of a geographic location associated with a product, such as a physical location of a product, a store premises within which a product is located, a digital product shelf tag associated with a product, and/or a wireless signal transmitter located at a store premises, for example. In response to a detection of geographic proximity, coupon distribution facility 106 may select and provide one or more electronic coupons to a consumer.

Electronic coupons may be selected for distribution to a consumer based on one or more predetermined coupon matching parameters. Examples of such parameters may include, but are not limited to, information included within profile data 120, coupon data 114, product data 116, and/or advertisement data 118. In certain embodiments, coupon distribution facility 106 may be configured to select one or more electronic coupons from a plurality of electronic coupons represented by coupon data 114 based at least in part on a navigation history (e.g., a store navigation history) generated by location tracking facility 104 as described above. For instance, an electronic coupon may be selected for distribution to a consumer based on data indicative of consumer shopping patterns (e.g., preferred day-of-week, time-of-day, and/or seasonal shopping patterns, durations of time spent by a consumer within a store premises, and/or durations of time spent by the consumer in one or more particular sections of the store premises) and/or any other information included in a navigation history.

In some examples, selection of electronic coupons for distribution to a consumer may be further based on a product purchase history of the consumer. The product purchase history may be obtained in any suitable way and may include any data representing past product purchases made by the consumer. In certain embodiments, the product purchase history may be generated by system 100 based at least in part on data descriptive of redemption of electronic coupons by the consumer.

Selected electronic coupons may be provided to a consumer in any suitable way. In certain embodiments, for example, content distribution facility 106 may distribute electronic coupons by transmitting coupon data 114 representing one or more electronic coupons to a mobile computing device and/or another access device associated with the consumer. Providing of electronic coupons may additionally or alternatively include displaying electronic coupons (e.g., on a display screen of a mobile computing device) for viewing and use by the consumer. Examples of distribution of electronic coupons are described in more detail further below.

Coupon collection facility 108 may be configured to associate one or more electronic coupons represented by coupon data 114 with a consumer coupon collection. To this end, coupon collection facility 108 may provide one or more coupon discovery tools configured to facilitate consumer access to electronic coupons maintained in data storage facility 112, such as by providing search, browsing, and/or other discovery tools for use by a consumer to discover and access one or more electronic coupons. For example, coupon distribution facility 106 may be configured to search coupon metadata to identify one or more particular electronic coupons based on user-provided search terms.

In addition, coupon collection facility 108 may provide one or more coupon collection tools configured to facilitate consumer collection of one or more accessed electronic coupons. With such tools, a consumer may discover and collect electronic coupons that are of value to the consumer. For example, a consumer may discover an electronic coupon and provide user input requesting that the electronic coupon be associated with the consumer, such as by saving the electronic coupon in a repository of electronic coupons collected by the consumer. Coupon collection facility 108 may receive the user input and respond by storing coupon data representative of the electronic coupon in, or otherwise associating the coupon data with, the repository of electronic coupons collected by the consumer. In certain examples, the electronic coupon may be associated with a consumer profile in profile data 120 to indicate that the electronic coupon has been collected by the consumer. In this or a similar manner, data representative of consumer collections of electronic coupons and coupon data representative of such consumer collected electronic coupons may be maintained by system 100. Examples of coupon collection tools are described in more detail further below.

Coupon utilization facility 110 may be configured to promote and/or assist with consumer utilization of electronic coupons. For example, coupon utilization facility 110 may provide one or more tools and/or perform one or more coupon utilization assistance operations configured to help a consumer with utilization of one or more electronic coupons, including electronic coupons that have been collected by the consumer. Such tools and/or operations may be configured to help with utilization of electronic coupons in any suitable way. For example, such tools and/or operations may be designed to improve efficiencies associated with utilization and/or redemption of electronic coupons.

In certain embodiments, coupon utilization facility 110 may be configured to detect an occurrence of one or more predetermined coupon utilization trigger events related to coupon data representing one or more electronic coupons. A coupon utilization trigger event may include any event or set of events defined for detection by coupon utilization facility 110 to trigger one or more coupon utilization assistance operations. As an example, a coupon utilization trigger event may include a receipt of user input expressly requesting help locating a product associated with an electronic coupon. As another example, a coupon utilization trigger event may comprise a detection of a geographic proximity of a mobile computing device associated with the consumer to a certain geographic location such as a physical location of a product associated with an electronic coupon. Examples of geographic proximity may include, but are not limited to, a mobile computing device located within or near a store premises within which a physical location of a product is located, a mobile computing device located within range and/or a predefined distance of a wireless signal transmitter positioned at a physical location of a product, and a mobile computing device located within a predetermined distance of a physical location of a product. The geographic proximity may be detected in any suitable way. For example, location tracking facility 104 may detect a location of a mobile computing device, and coupon utilization facility 110 may compare the detected location of the mobile computing device (e.g., geographic position coordinates of the mobile computing device) to the physical location of the product (e.g., geographic position coordinates of the product) associated with electronic coupon and determine, based on the comparison, whether the location of the mobile computing device is within a predefined geographic proximity of the physical location of the product. For instance, coupon utilization facility 110 may determine that the mobile computing device is located within a store premises in which the physical location of the product is located and/or within a predefined distance of the physical location of the product. As another example, the geographic proximity may be detected by the mobile computing device receiving a signal from a wireless signal transmitter (e.g., a Wi-Fi or Bluetooth transmitter) located at or near the physical location of the product.

Coupon utilization facility 110 may be configured to perform one or more coupon utilization assistance operations in response to a detected occurrence of a predetermined coupon utilization trigger event. In certain embodiments, for example, coupon utilization facility 110 may provide, in response to a coupon utilization trigger event, a message for presentation to a consumer via the mobile computing device associated with the consumer. The message may be configured to promote and/or assist with utilization of one or more electronic coupons, including one or more electronic coupons collected by the consumer. As an example, the message may indicate one or more electronic coupons selected from a consumer collection of electronic coupons that are associated with one or more products located proximate to the geographic location of the mobile computing device. Such a message may include a list of electronic coupons associated with one or more products located proximate to the geographic location of the mobile computing device. The electronic coupons may be arranged in a prioritized order within the list based on any suitable prioritization parameters. Additionally or alternatively, the message may include a list of the products associated with the electronic coupons. As another example, the message may be configured to direct the consumer to a physical location of a product associated with an electronic coupon. For instance, the message may include directions from the location of the mobile computing device to the physical location of the product. Such directions may include at least one directional arrow visually indicating at least one direction of travel from the location of the mobile computing device to the physical location of the product and/or an indication of a distance from the location of the mobile computing device to the physical location of the product.

In certain examples, the directions may comprise an indication of an optimal path of travel from the location of the mobile computing device to the physical location of the product. The indication of the optimal path of travel may be displayed by the mobile computing device for viewing by the consumer. In some examples, the optimal path may be displayed within a map of a geographic area within which the physical location of the product is located. To illustrate, in certain embodiments, the optimal path may indicate an optimal path within a store premises from the location of the mobile computing device to the physical location of the product. Such an optimal path may be displayed by the mobile computing device within a map of at least a portion of the store premises. The optimal path of travel may help guide a consumer to a product such that the consumer is able to efficiently locate and procure the product, which may facilitate purchase of the product and redemption of the associated electronic coupon.

The optimal path of travel from the location of the mobile computing device to the physical location of the product may be determined in any suitable way based on one or more predetermined path selection parameters. Examples of such parameters may include, without limitation, prioritized preferences such as shortest travel distance, quickest travel time, etc. In certain embodiments, coupon utilization facility 110 may be configured to determine an optimal path of travel based at least in part on a navigation history of a mobile computing device, such as a navigation history generated by location tracking facility 104 as described above. For instance, an optimal path of travel within a store premises may be determined based at least in part on a store navigation history that has been determined by tracking the location of a mobile computing device associated with the consumer within the store premises over time. This may allow coupon utilization facility 110 to select an optimal path that traverses a certain section of a store premises frequently visited by the consumer. For example, a store navigation history may indicate that the consumer frequently visits a produce section in a grocery store. Coupon utilization facility 110 may leverage this data to select an optimal path of travel that passes through the produce section of the grocery store.

In certain examples, coupon utilization facility 110 may determine an optimal path of travel based on physical locations of multiple products associated with electronic coupons collected by a consumer. For example, the consumer may have collected electronic coupons for multiple products available for purchase within a store premises. Coupon utilization facility 110 may, in response to a detected occurrence of a coupon utilization trigger event (e.g., a mobile computing device associated with the consumer entering the store premises), determine and provide an optimal path of travel to each of the multiple products in the store premises.

As another example, a message provided by coupon utilization facility 110 may be configured to remind a consumer of at least one electronic coupon collected by the consumer. For instance, the message may remind the consumer of an electronic coupon that has an upcoming expiration date and/or that has been in a repository of collected coupons for a certain duration of time (e.g., for a month). Additionally or alternatively, a message provided by coupon utilization facility 110 may be configured to notify the consumer of a detected geographic proximity, such as a detected geographic proximity of a mobile computing device associated with the consumer to a geographic location associated with a product, such as a store premises within which a product associated with an electronic coupon is located. As yet another example, a message provided by coupon utilization facility 110 may be configured to provide information about a product associated with an electronic coupon. For example, the message may include an advertisement and/or an informational video about the product for presentation to the consumer via the mobile computing device. Examples of coupon utilization trigger events and coupon utilization assistance operations are described in more detail further below.

Data storage facility 112 may be configured to maintain coupon content data 114, product data 116, advertisement data 118, profile data 120, and/or any other data as may serve a particular application. Data storage facility 112 may include and/or employ any data storage devices, computer-readable media, and technologies suitable for storing electronic data.

System 100, including facilities 102-112, may include any computer hardware and/or computer-implemented instructions (e.g., software), or combinations of computer-implemented instructions and hardware, configured to perform one or more of the processes described herein. In particular, system 100 may be implemented on one physical computing device or may be implemented on more than one physical computing device. Accordingly, system 100 may include any number of computing devices, and may employ any of a number of computer operating systems.

One or more of the processes described herein may be implemented at least in part as instructions executable by one or more computing devices. In general, a processor (e.g., a microprocessor) receives instructions, from a computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media and/or volatile media. Common forms of computer-readable media include, for example, a floppy disk, flexible disk, hard disk, magnetic tape, any other magnetic medium, a CD-ROM, DVD, any other optical medium, a RAM, a DRAM a PROM, an EPROM, a FLASH-EEPROM, any other memory chip or cartridge, or any other medium from which a computer can read.

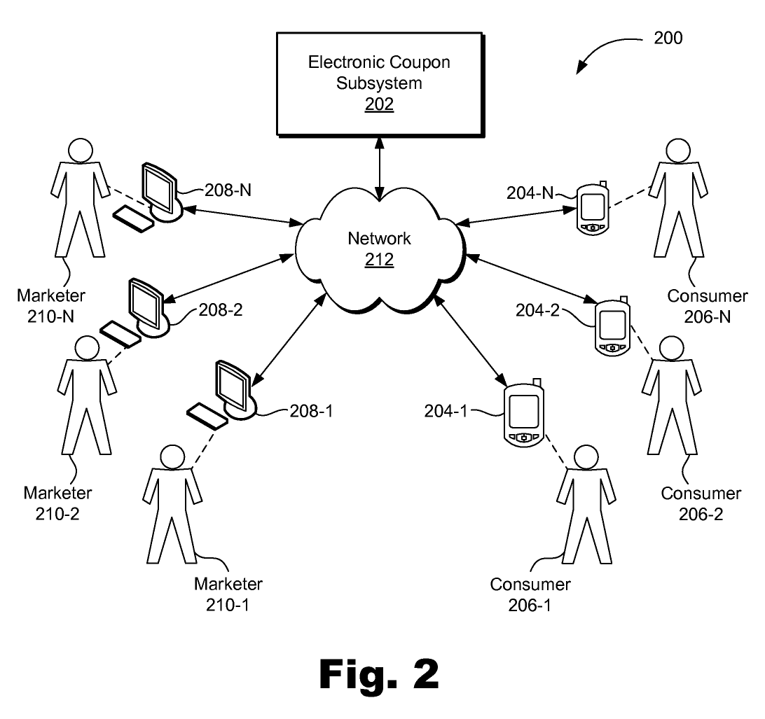

FIG. 2 illustrates an exemplary implementation 200 of system 100. As shown in FIG. 2, implementation 200 may include an electronic coupon subsystem 202 (or simply “coupon subsystem 202”) selectively and communicatively connected to a plurality of access devices 204 (e.g., computing devices 204-1 through 204-N) associated with a plurality of consumers 206 (e.g., consumers 206-1 through 206-N) and to a plurality of access devices 208 (e.g., computing devices 208-1 through 208-N) associated with a plurality of marketers 210 (e.g., consumers 210-1 through 210-N).

Coupon subsystem 202 may communicate with access devices 204 and 208 using any communication platforms and technologies suitable for transporting data and/or communication signals, including known communication technologies, devices, media, and protocols supportive of remote data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, wireless communication technologies, in-band and out-of-band signaling technologies, and other suitable communications networks and technologies. Any suitable registration and/or authentication technologies may be employed to register and/or authenticate devices and/or users for communications with coupon subsystem 202.

Coupon subsystem 202 may communicate with access devices 204 and 208 via a network 212, which may include one or more networks, including, but not limited to, wireless networks (Wi-Fi networks), (e.g., wireless communication networks), mobile telephone networks (e.g., cellular telephone networks), closed media networks, open media networks, closed communication networks, open communication networks, satellite networks, navigation networks, broadband networks, narrowband networks, voice communication networks (e.g., VoIP networks), the Internet, and any other networks capable of carrying data and/or communications signals between access devices 204 and 208 and coupon subsystem 202. Communications between coupon subsystem 202 and access devices 204 and 208 may be transported using any one of above-listed networks, or any combination or sub-combination of the above-listed networks. In certain exemplary embodiments, network 212 includes a mobile telephone network.

Access devices 208 may include any computing devices associated with marketers 210 and configured to communicate with coupon subsystem 202. Accordingly, marketers 210 may utilize access devices 208 to provide (e.g., upload) data representative of electronic coupons, products, and/or advertisements to coupon subsystem 202, which may store, aggregate, organize, and maintain data representative of the electronic coupons, products, and/or advertisements. Marketers 210 may also utilize access devices 208 to manage data representative of the electronic coupons, products, and/or advertisements maintained in coupon subsystem 202. For example, a marketer 210 may modify settings and/or other data associated with electronic coupons, products, and/or advertisement such as by changing data identifying a physical location of a product to reflect a relocation of the product (e.g., a move from one shelf location to another shelf location within a store premises).

Access devices 204 may include any mobile computing devices (e.g., mobile phone devices) associated with consumers 206 and configured to communicate with coupon subsystem 202. Accordingly, consumers 206 may utilize access devices 204 to access data representative of electronic coupons, products, and/or advertisements from coupon subsystem 202. In addition, consumers 206 may utilize access devices 204 to access one or more coupon distribution, collection, and/or utilization tools, operations, and/or services provided by coupon subsystem 202. While FIG. 2 shows each consumer 206 to be associated with one access device 204 in the form of a mobile computing device, this is illustrative only. A consumer 206 may utilize additional access devices (e.g., a set-top-box device, a gaming console device, a personal computer device, etc.) to access certain data, tools, operations, and/or services provided by coupon subsystem 202. However, certain data, tools, operations, and/or services provided by coupon subsystem 202 may be specific to a mobile computing device associated with a consumer 206.

Coupon subsystem 202 may include one or more computing devices (e.g., one or more server devices) implementing one or more components of system 100. In certain embodiments, system 100 may be implemented entirely by or within coupon subsystem 202. In other embodiments, components of system 100 may be distributed across coupon subsystem 202 and access devices 204 and/or 208. For example, an access device 204 may include a client (e.g., a client application) implementing one or more components of system 100.

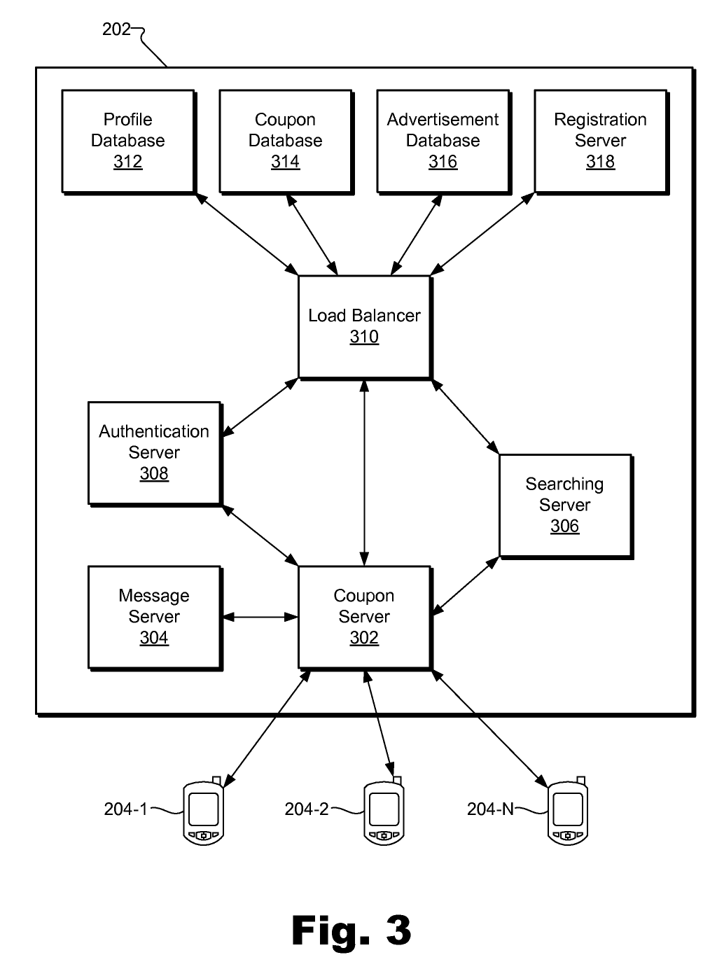

FIG. 3 illustrates exemplary components of coupon subsystem 202. The components illustrated in FIG. 3 are illustrative only. Other components and/or configurations may be employed in other embodiments. As shown, coupon subsystem 202 may include a coupon server 302 in communication with a plurality of access devices 204 (e.g., access devices 204-1 through 204-N). Coupon server 302 may also be in communication with a message server 304, a search server 306, an authentication server 308, and a load balancer 310. Coupon server 302, search server 306, and authentication server 308 may access data maintained in a profile database 312, a coupon database 314, an advertisement database 316, and a registration server 318 through load balancer 310. For example, search server 306 may search for specific data maintained in profile database 312, coupon database 314, and/or advertisement database 316. Accordingly, search server 306 may search for and identify particular consumer profiles, electronic coupons, and/or advertisements. Search server 306 may retrieve and forward the identified data to coupon server 302, which may transmit the data to one or more access devices 204. As another example, authentication server 308 may search for data maintained by registration server 318 to determine whether a particular access device 204 and/or consumer 206 is registered and/or authenticated to access coupon server 302. Load balancer 310 may be configured to balance data traffic loads associated with accessing profile database 312, coupon database 314, advertisement database 316, and registration server 318. Message server 304 may be configured to function in conjunction with coupon server 302 to generate and provide one or more messages to one or more access devices 204, including any of the exemplary messages described herein.

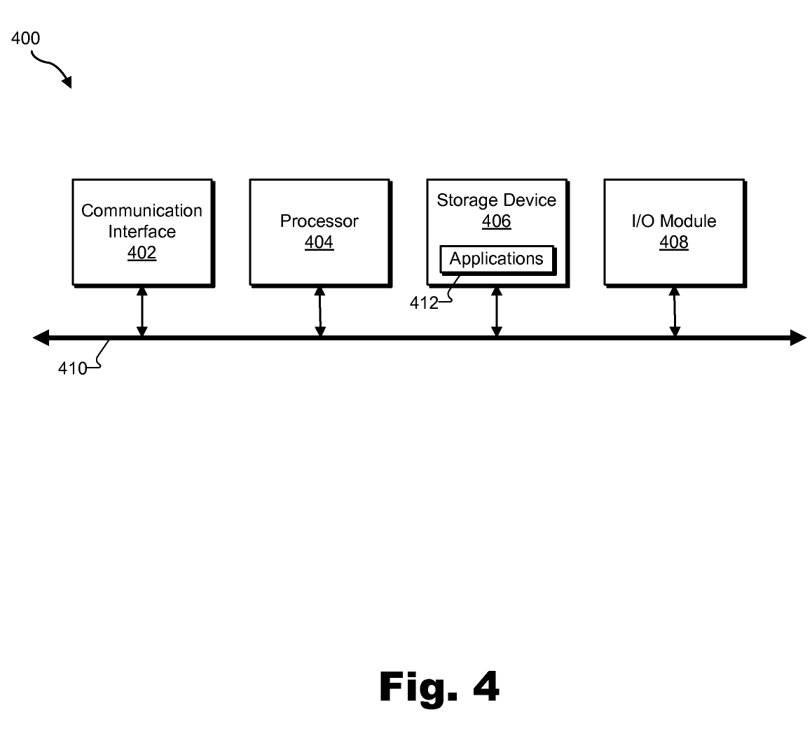

FIG. 4 illustrates an exemplary electronic coupon processing device 400 (or simply “device 400”). One or more components of system 100 may be implemented by or on device 400. Additionally or alternatively, electronic coupon subsystem 202 and/or access device 204 or 208 may include or be implemented by device 400. As shown in FIG. 4, device 400 may include a communication interface 402, a processor 404, a storage device 406, and an input/output (“I/O”) module 408 communicatively coupled one to another via a communication infrastructure 410. The components of device 400 may communicate with one another, including sending data to and receiving data from one another, using any suitable communication technologies. Moreover, the components of device 400 may be implemented on any computing device or combination of computing devices configured to process electronic coupons, such as any of the computing devices disclosed herein.

While an exemplary device 400 is shown in FIG. 4, the components illustrated in FIG. 4 are not intended to be limiting. Additional or alternative components may be used in other embodiments. Components of the device 400 shown in FIG. 4 will now be described in additional detail.

Communication interface 402 may be configured to communicate with one or more computing devices. In particular, communication interface 402 may be configured to transmit and/or receive communication signals and/or data to/from an access device and/or an electronic coupon source device. Examples of communication interface 402 include, without limitation, a wired network interface (such as a network interface card), a wireless network interface (such as a wireless network interface card), a modem, an optical fiber network terminal, and any other suitable interface.

Processor 404 generally represents any type or form of processing unit capable of processing data or interpreting, executing, and/or directing execution of one or more of the instructions, processes, and/or operations described herein. Processor 404 may direct execution of operations in accordance with one or more applications 412 or other computer-executable instructions such as may be stored in storage device 406 or another computer-readable medium.

Storage device 406 may include one or more data storage media, devices, or configurations and may employ any type, form, and combination of data storage media and/or device. For example, storage device 406 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 406. For example, data representative of one or more executable applications 412 configured to direct processor 404 to perform any of the operations described herein may be stored within storage device 406. In some examples, data may be arranged in one or more databases residing within storage device 406.

I/O module 408 may be configured to receive user input and provide user output and may include any hardware, firmware, software, or combination thereof supportive of input and output capabilities. For example, I/O module 408 may include one or more devices for capturing user input, including, but not limited to, a microphone, a keyboard or keypad, a touch screen component (e.g., touch screen display), a data receiver (e.g., an RF or infrared receiver), and/or one or more input buttons.

I/O module 408 may include one or more devices for presenting output to a user, including, but not limited to, a graphics engine, a display (e.g., a display screen, one or more output drivers (e.g., display drivers), one or more audio speakers, one or more audio drivers, and a data transmitter. In certain embodiments, I/O module 408 is configured to provide (e.g., transmit) graphical data to a display and/or user access device for presentation to a user. The graphical data may be representative of one or more graphical user interfaces (“GUIs”), GUI views, coupon content views, message views, and/or any other view as may serve a particular implementation.

In some examples, one or more of the facilities 102-112 of system 100 shown in FIG. 1 may be implemented by or within one or more components of device 400. For example, one or more applications 412 residing within storage device 406 may be configured to direct processor 404 to perform one or more processes or functions associated with one or more facilities 102-110. Likewise, data storage facility 112 may be implemented by or within storage device 406. For example, coupon content data 114, product data 116, advertisement data 118, and profile data 120 may be stored within storage device 406.

Exemplary processes, operations, tools, options, and/or user interfaces associated with distributing, collecting, and utilizing electronic coupons will now be described. One or more of the exemplary processes, operations, tools, options, and/or user interfaces may be performed and/or provided by system 100, coupon subsystem 202, access device 204 or 208, and/or device 400.

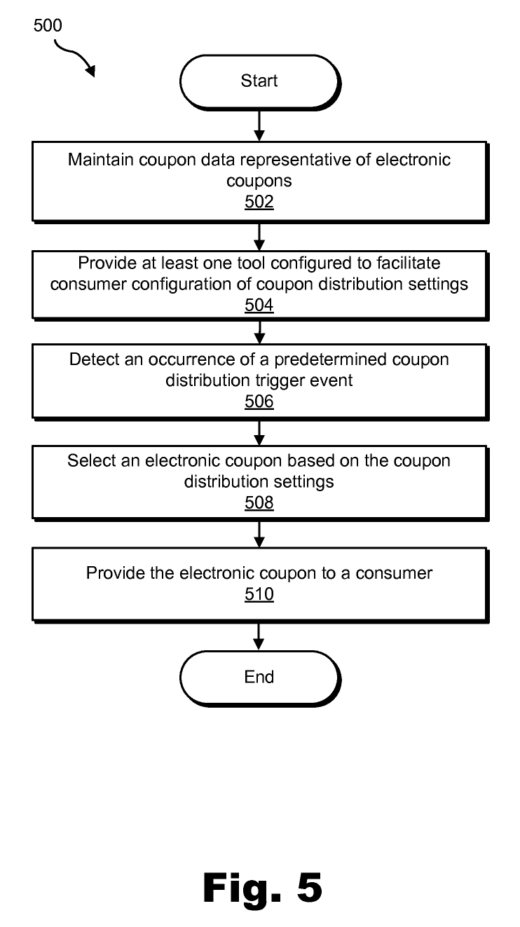

FIG. 5 illustrates an exemplary electronic coupon distribution method 500. While FIG. 5 illustrates exemplary steps according to one embodiment, other embodiments may omit, add to, reorder, and/or modify any of the steps shown in FIG. 5.

In step 502, coupon data representative of one or more electronic coupons is maintained. For example, data management facility 102 may maintain coupon data 114 representative of one or more electronic coupons provided by one or more marketers 210 for storage in data storage facility 112.

In step 504, at least one tool configured to facilitate consumer configuration of coupon distribution settings is provided. For example, coupon distribution facility 106 may provide one or more tools for use by a consumer to configure one or more coupon distribution settings. In certain embodiments, the tools may comprise a settings configuration GUI and/or one or more tools within the GUI.

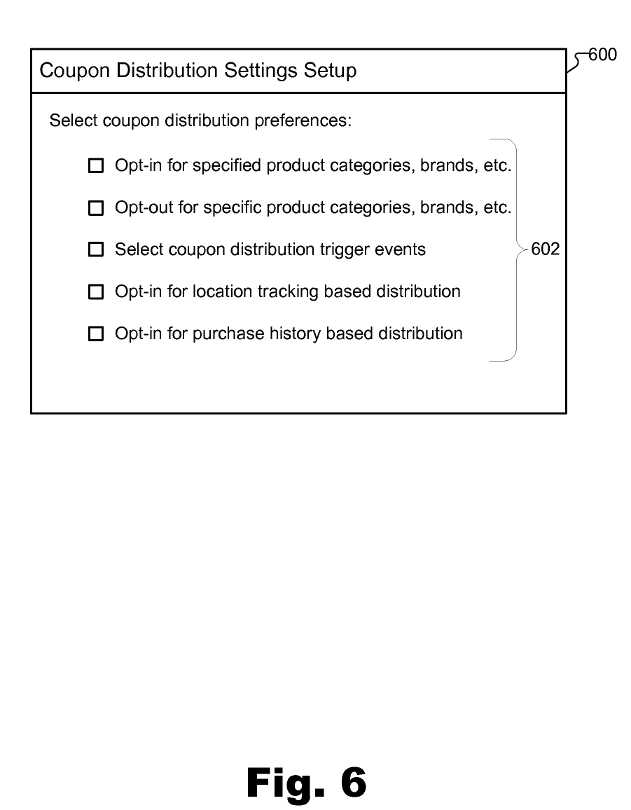

To illustrate, FIG. 6 shows an exemplary GUI 600 configured to facilitate consumer configuration of one or more coupon distribution settings. As shown, GUI 600 may include a list of selectable coupon distribution settings options 602 configured to facilitate consumer configuration of coupon distribution settings. As shown in the illustrated example, options 602 may include an option for opting in to receive electronic coupons for consumer-specified products, product categories, product brands, etc., an option for opting out receiving electronic coupons for consumer-specified products, product categories, product brands, etc., an option for selecting coupon distribution triggered events to be used to trigger one or more coupon distribution operations, an option for opting in for location tracking based distribution of electronic coupons, and an option for opting in for purchase history based distribution of electronic coupons. Accordingly, a consumer may select one or more products, product categories, and/or product brands for which the consumer wishes to receive or not receive electronic coupons. In addition, a consumer may select one or more coupon distribution trigger events to be used to trigger distribution of electronic coupons to the consumer. Consumer selectable distribution triggered events may include any of the coupon distribution triggered events described herein, including, for example, one or more geographic proximity based trigger events. A consumer may also opt in to location tracking and/or purchase history based coupon distribution, and coupon distribution facility 106 may thereafter distribute electronic coupons to the consumer based at least in part on a location navigation history and/or a purchase history of the consumer.

While FIG. 6 illustrates exemplary coupon distribution settings options 602, the exemplary options 602 are illustrative only. Other tools and/or options for consumer configuration of coupon distribution settings may be provided in other embodiments.

Returning now to FIG. 5, in step 506, an occurrence of a predetermined coupon distribution triggered event is detected. For example, coupon distribution facility 106 may detect the occurrence of the coupon distribution triggered event, which may include any of the coupon distribution trigger events described herein. In certain examples, the detected coupon distribution trigger event may include a coupon distribution triggered event selected by a consumer using a tool provided in step 504.

In step 508, an electronic coupon is selected based on the coupon distribution settings. For example, in response to the coupon distribution trigger event detected in step 506, coupon distribution facility 106 may select an electronic coupon based on the coupon distribution settings defined by a consumer in step 504. For instance, coupon distribution facility 106 may identify the electronic coupon as matching a product, product category, and/or product brand identified as being of interest to the consumer in step 504.

In step 510, the electronic coupon selected in step 508 is provided to the consumer. Step 510 may be performed in any of the ways described herein. For example, coupon distribution facility 106 may transmit coupon data representative of the electronic coupon to a mobile computing device and/or another access device associated with the consumer.

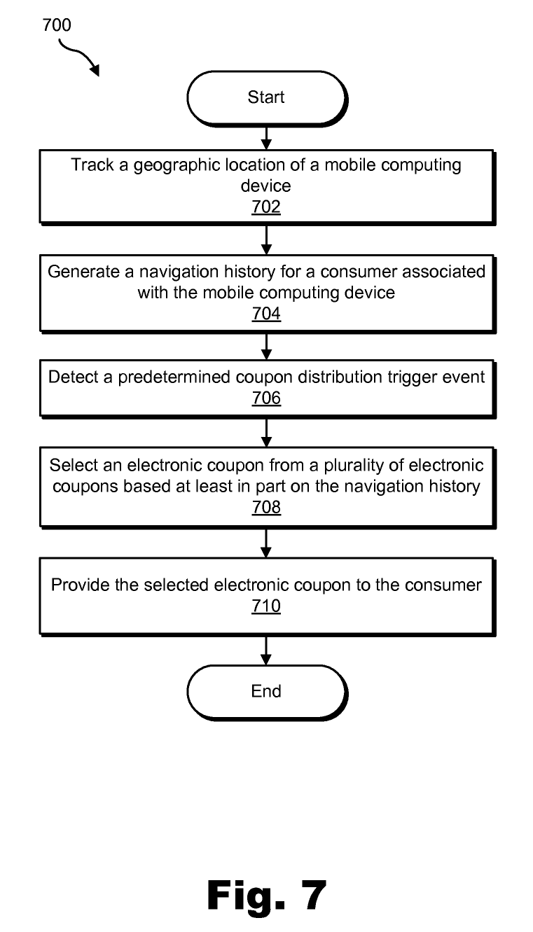

As mentioned, in certain examples, distribution of electronic coupons may be based at least in part on a location navigation history of a mobile computing device associated with a consumer. To illustrate, FIG. 7 shows another exemplary electronic coupon distribution method 700. While FIG. 7 illustrates exemplary steps according to one embodiment, other embodiments may omit, add to, reorder, and/or modify any of the steps shown in FIG. 7.

In step 702, a geographic location of a mobile computing device is tracked. For example, location tracking facility 104 may track the geographic location of the mobile computing device as described above.

In step 704, a navigation history for a consumer associated with the mobile computing device is generated. For example, location tracking facility 104 may generate the navigation history for the consumer associated with the mobile computing device as described above.

In step 706, an occurrence of a predetermined coupon distribution trigger event is detected. Step 706 may be performed in any of the ways described above.

In step 708, an electronic coupon is selected from a plurality of electronic coupons based at least in part on the navigation history generated in step 704. For example, coupon distribution facility 106 may select the electronic coupon from the plurality of electronic coupons represented by coupon data 114 in data storage facility 112 based at least in part on the navigation history. This may allow targeted electronic coupons to be selected for distribution to a consumer based on tracked locations of a mobile computing device associated with the consumer, which tracked locations may be indicative of consumer preferences, interests, and/or habits toward one or more products. To illustrate, a navigation history may include data indicating that each time a consumer shops at a particular store, the consumer exhibits a pattern of spending significant amounts of time in a particular product section within a store premises. Accordingly, coupon distribution facility 106 may select electronic coupons associated with products in the product section for distribution to the consumer.

In step 710, the selected electronic coupon is provided to the consumer. Step 710 may be performed in any of the ways described above.

System 100 may be configured to provide one or more tools for use by a consumer in selecting how to process electronic coupons distributed to the consumer. For example, coupon collection facility 108 may provide a consumer with one or more tools configured to assist the consumer with collecting electronic coupons that are of value to the consumer and discarding electronic coupons that are not of value to the consumer.

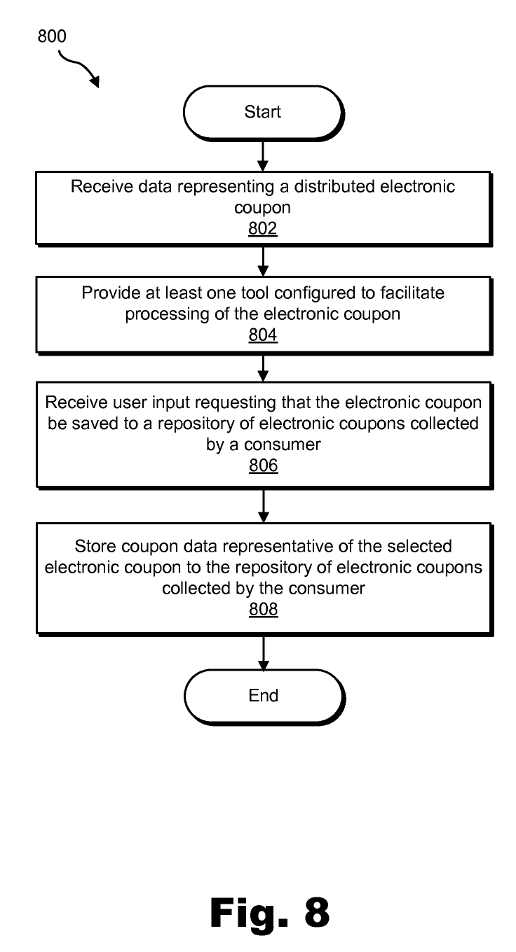

To illustrate, FIG. 8 shows an exemplary electronic coupon collection method 800. While FIG. 8 illustrates exemplary steps according to one embodiment, other embodiments may omit, add to, reorder, and/or modify any of the steps shown in FIG. 8.

In step 802, data representing a distributed electronic coupon is received. For example, a mobile computing device associated with a consumer may receive data representing an electronic coupon distributed by coupon subsystem 202.

In step 804, at least one tool configured to facilitate processing of the electronic coupon is provided. For example, the mobile computing device associated with the consumer may provide at least one tool for use by the consumer to direct processing of electronic coupon. In certain embodiments, data representing the electronic coupon may be displayed by the mobile computing device for viewing by the consumer. In addition or alternative to a display of the electronic coupon, the mobile computing device may be configured to provide one or more selectable options that may be selected by the consumer to direct processing of the electronic coupon. In certain embodiments, the tools may be provided within a GUI presented by the mobile computing device.

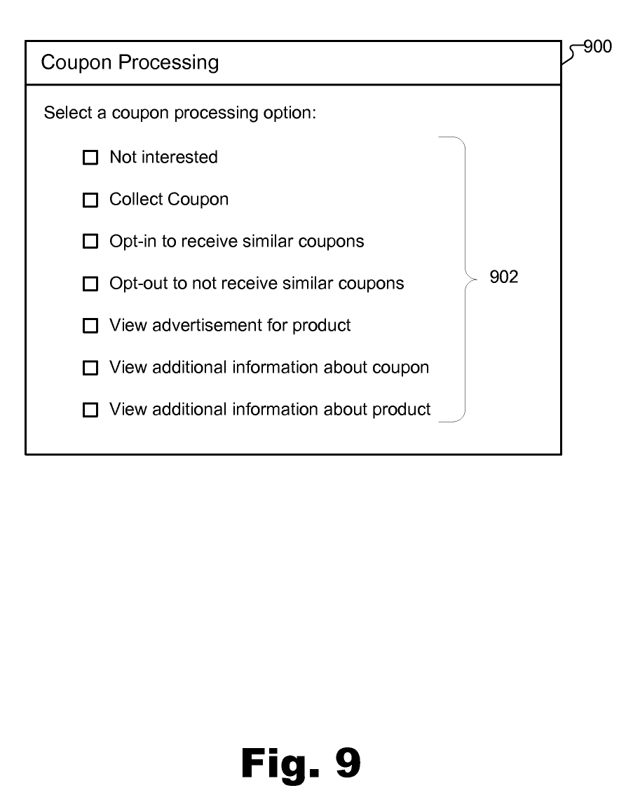

To illustrate, FIG. 9 shows an exemplary GUI 900 including a list of selectable coupon processing options 902 configured to facilitate processing of an electronic coupon. As shown in the illustrated example, options 902 may include an option for indicating that the consumer is not interested in an electronic coupon, an option for collecting the electronic coupon, an option for opting in to receive similar coupons (e.g., other electronic coupons associated with the same product, product category, and/or product brand associated with the electronic coupon), an option for opting out to not receive similar coupons (e.g., other electronic coupons for the product, product category, and/or product brand associated with the electronic coupon), an option for viewing an advertisement and/or an informational video about a product associated with the electronic coupon, an option for viewing additional information about the electronic coupon, and an option for viewing additional information about the product associated with the electronic coupon. A consumer may select one or more of the options 902 to direct processing related to the electronic coupon, including indicating how the electronic coupon is to be processed by the mobile computing device. For example, the consumer may select the “not interested” option to indicate that the consumer is not interested in the electronic coupon. In response, the mobile computing device may discard the electronic coupon. As another example, the consumer may select the “collect coupon” option to indicate that the consumer wants to keep the electronic coupon. In certain examples, a consumer selection of the “collect coupon” option may indicate a request that the electronic coupon be saved to a repository of electronic coupons collected by the consumer.

Returning to FIG. 8, in step 806, user input requesting that the electronic coupon be saved to a repository of electronic coupons collected by the consumer is received. Such user input may be provided by a consumer and received by a mobile computing device associated with the consumer and/or coupon subsystem 202 in any suitable way.

In step 808, coupon data representative of the selected electronic coupon is stored to a repository of electronic coupons collected by the consumer. Coupon data representative of the selected electronic coupon may be stored or otherwise associated with the repository of electronic coupons collected by the consumer in any suitable way. For example, the coupon data may be saved to local memory within the mobile computing device. Additionally or alternatively, the coupon data may be stored to a remote data storage site such as a data store located at coupon subsystem 202. In certain embodiments, the coupon data may be associated with the repository of electronic coupons collected by the consumer by associating the coupon data with a consumer profile. Accordingly, a consumer may collect electronic coupons that are of value to the consumer for subsequent utilization. Step 808 may be performed in response to the user input received in step 806.

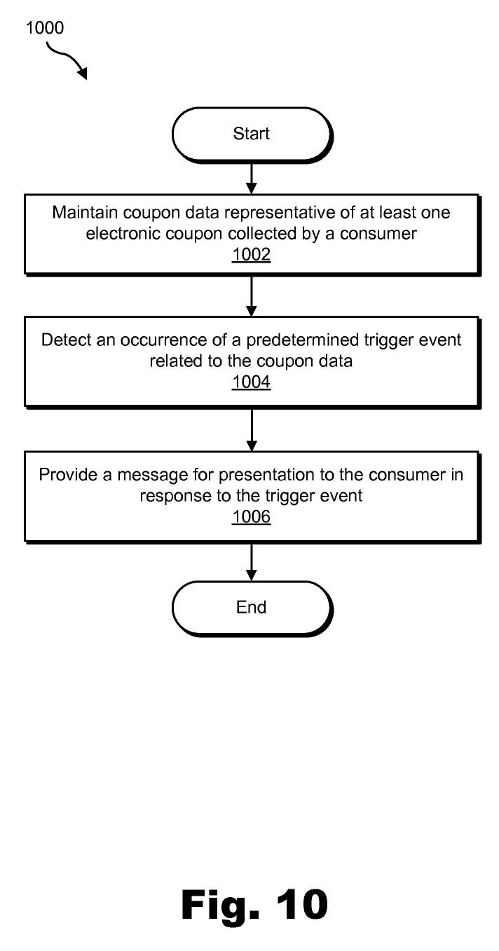

System 100 may be configured to provide one or more tools and/or perform one or more operations configured to assist with utilization of electronic coupons distributed to and/or collected by a consumer. For example, FIG. 10 illustrates an exemplary electronic coupon utilization method 1000. While FIG. 10 illustrates exemplary steps according to one embodiment, other embodiments may omit, add to, reorder, and/or modify any of the steps shown in FIG. 10.

In step 1002, coupon data representative of least one electronic coupon collected by a consumer is maintained. The collected coupon data may be maintained in any suitable way such that the coupon data is accessible by a mobile computing device associated with the consumer. For example, coupon data representing one or more collected electronic coupons may be stored locally within the mobile computing device and/or remotely at a data store site accessible to the mobile computing device.

In step 1004, an occurrence of a predetermined trigger event related to the coupon data is detected. The predetermined trigger event may include any of the coupon utilization trigger events described herein and related to the coupon data representative of at least one electronic coupon collected by the consumer. For example, the trigger event may include a detected geographic proximity of the mobile computing device associated with the consumer to a geographic location associated with a product associated with at least one electronic coupon collected by the consumer.

In step 1006, a message is provided for presentation to the consumer in response to the trigger event detected in step 1004. The message may be provided in any suitable way. For example, coupon subsystem 202 and/or coupon utilization facility 110 may transmit data representative of the message to the mobile computing device associated with the consumer. Additionally or alternatively, the message may be presented by the mobile computing device for experiencing by the consumer.

The message may be configured to promote and/or assist the consumer with utilization of one or more electronic coupons. For example, the message may indicate one or more electronic coupons associated with products that are physically located within a geographic proximity of the mobile computing device associated with the consumer. Hence, the message may notify the consumer of a convenient opportunity to utilize and redeem one or more electronic coupons based on a geographic proximity of the mobile computing device associated with the consumer to one or more locations of products associated with one or more electronic coupons.

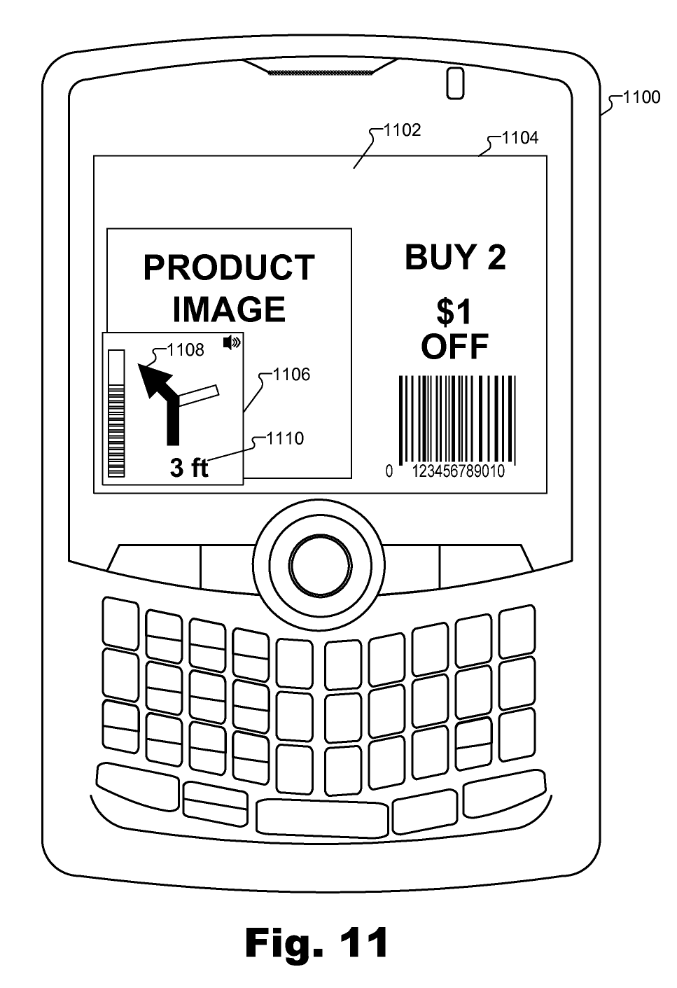

In certain embodiments, the message may be configured to direct the consumer to one or more physical locations of one or more products associated with one or more electronic coupons. As described above, for example, the message may include directions from the location of the mobile computing device associated with the consumer to one or more physical locations of one or more products associated with one or more electronic coupons. To illustrate, FIG. 11 shows an exemplary mobile phone device 1100 having a GUI 1102 displayed on a display screen 1104 of the mobile phone device 1100. As shown, GUI 1102 may include data visually depicting an electronic coupon. The data may include any information related to the electronic coupon including, for example, information descriptive of a discount offered by the electronic coupon, data descriptive of a product associated with electronic coupon (e.g., a visual image of the product), and a barcode associated with the electronic coupon (e.g., a product barcode).

In addition, GUI 1102 may include a message 1106 displayed for viewing by a consumer. As shown, message 1106 may include directions from the location of mobile phone device 1100 to a physical location of a product associated with the electronic coupon depicted in GUI 1102. In the illustrated example, the directions include a directional arrow 1108 indicating at least one direction of travel from the location of mobile phone device 1100 to the physical location of the product. In addition, the directions may include an indication 1110 of a distance from the location of mobile phone device 1100 to the physical location of the product. Accordingly, message 1106 may assist the consumer in locating, navigating to, and procuring the product associated with the electronic coupon depicted in GUI 1102.

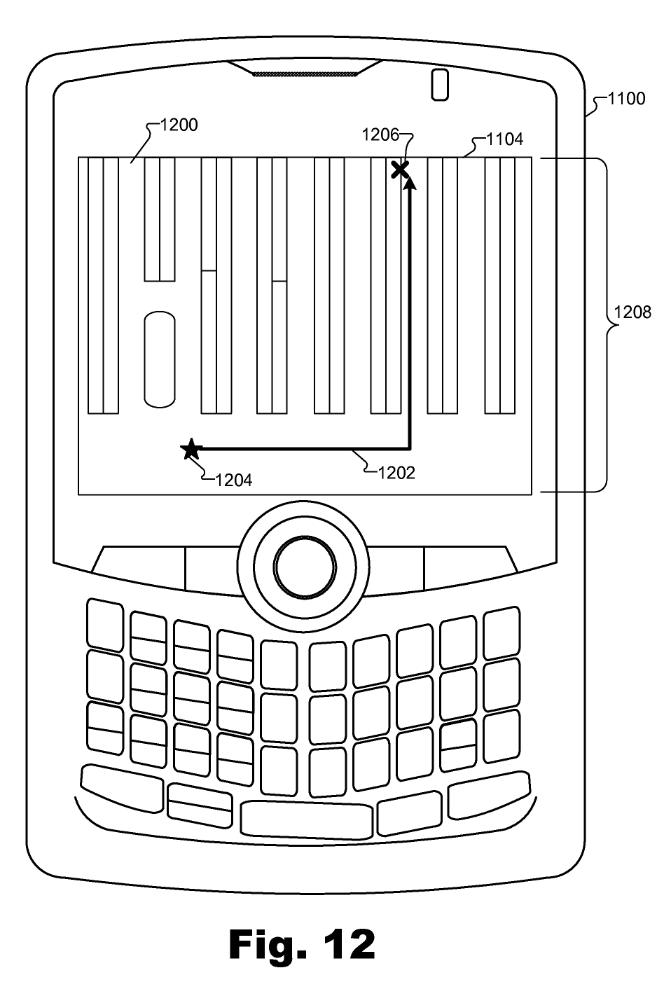

As another example, the directions may include an indication of an optimal path of travel from the location of mobile phone device 1100 to the physical location of the product. To illustrate, FIG. 12 shows an exemplary GUI 1200 displayed on the display screen 1104 of mobile phone device 1100. As shown, GUI 1200 includes a visual depiction of an optimal path 1202 from the location of mobile phone device 1100 to the physical location of the product associated with the electronic coupon. In FIG. 12, the location of mobile phone device 1100 is represented as reference number 1204, and the physical location of the product is represented as reference number 1206.

In certain examples, optimal path 1202 may indicate an optimal path of travel within a store premises. In addition, in certain examples, optimal path 1202 may be displayed within a map of at least a portion of the store premises. FIG. 12 illustrates an indication of optimal path 1202 displayed within a map 1208 of a portion of a store premises in GUI 1200. Accordingly, the consumer may conveniently view and follow an optimal path of travel from a current location of the consumer to a physical location of a product associated with an electronic coupon.

While FIG. 12 illustrates an optimal path 1202 from the location 1204 of mobile phone device 1100 to a product location 1206 of a single product associated with the electronic coupon, this is illustrative only. In other examples, an optimal path may depict an optimal path of travel from the location 1204 of mobile phone device 1100 to multiple locations of multiple products associated with electronic coupons. Accordingly, the consumer make conveniently view and follow an optimal path of travel throughout a store premises to locate and pick up multiple products associated with multiple electronic coupons collected by the consumer.

In certain embodiments, system 100 may provide one or more tools configured to facilitate consumer configuration of coupon utilization settings. For example, system 100 may provide one or more selectable options that may be selected by a consumer to define one or more coupon utilization trigger events (e.g., one or more specific geographic proximities) that will be used to trigger performance of coupon utilization assistance operations, one or more such operations that will be performed in response to certain trigger events, and messages that will be provided in response to certain trigger events. For example, a consumer may specify whether a message will include a directional arrow and/or an optimal path configured to direct the consumer to a location of a product. As another example, a consumer may specify parameters to be used to create prioritized lists of electronic coupons within a message. These examples of coupon utilization settings are illustrative only. A consumer may be provided with other configuration options in other embodiments.

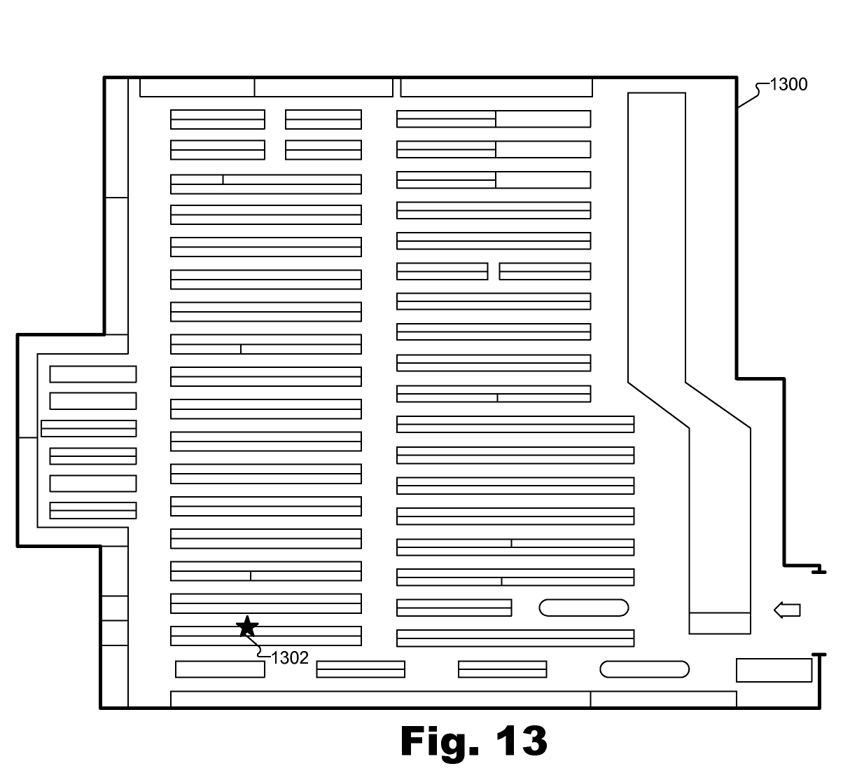

As mentioned in several examples described above, one or more of the principles described herein may be applied for electronic coupon distribution, collection, and/or utilization in relation to a particular geographic space such as a store premises. FIG. 13 illustrates an exemplary map layout 1300 of a store premises. One or more of the electronic coupon distribution, collection, and/or utilization processes and/or operations described herein may be performed in relation to the store premises. For example, one or more of the electronic coupon distribution, collection, and/or utilization processes and/or operations described herein may be performed in response to and/or based on a detected geographic location of a mobile computing device relative to the store premises and/or one or more physical locations within the store premises.

As an example, an operator of a store located at the store premises may elect to participate in one or more electronic coupon services provided by system 100. Accordingly, data representing information about the store premises and/or products available for purchase at the store premises may be gathered and maintained in data storage facility 112. For example, product data 116 may include information indicating one or more products that are available for purchase at the store premises as well as geographic location data indicating a geographic space of the store premises and/or of one or more physical locations (e.g., physical locations of products and/or wireless signal transmitters) within the store premises. Accordingly, system 100 may perform one or more of the operations described herein in relation to data associated with the store premises.

To illustrate, a consumer may register for one or more electronic coupon services provided by system 100, and a mobile computing device associated with a consumer may be configured to access the electronic coupon service(s). In some embodiments, this may include accessing one or more electronic coupon services provided remotely by coupon subsystem 202 and/or installing and executing a client application on the mobile computing device.

With an electronic coupon service and/or application running on the mobile computing device associated with the consumer, the geographic location of the mobile computing device may be tracked to determine an occurrence of a geographic proximity of the mobile computing device to a geographic location associated with the store premises. The detected geographic proximity may be used to trigger performance of one or more of the electronic coupon distribution, collection, and/or utilization operations described herein. The geographic proximity may include any of the examples of geographic proximity described herein.

As an example, when the consumer enters the store premises while carrying the mobile computing device, system 100 may detect that the mobile computing device has entered within the store premises. In response, system 100 may search product data 116 and identify one or more products that are available for purchase within the store premises. System 100 may then identify one or more electronic coupons represented by coupon data 114 that are associated with one or more of the products available for purchase within the store premises. System 100 may then select one or more of the identified electronic coupons for distribution to the mobile computing device associated with the consumer. Electronic coupons may be selected in a targeted manner in any of the ways described above such that relevant electronic coupons that are of value to the consumer are likely to be selected and distributed to the consumer. Accordingly, when the consumer enters the store premises, the consumer may be made aware of one or more electronic coupons that can be used to gain a discount when purchasing one or more products available for purchase within the store premises.

As another example, as the consumer navigates within the store premises, the consumer may carry the mobile computing device within a geographic proximity of a particular location within the store premises. For example FIG. 13 illustrates a predefined location 1302 within the store premises. The predefined location 1302 may include a location of a product, a location of a digital tag of a product, and/or a location of a wireless coupon distribution transmitter located within the store premises. In some examples, the predefined location 1302 may be a coupon distribution “hot spot” located within the store premises. For example, a wireless coupon distribution transmitter may be established at location 1302 and configured to distribute one or more electronic coupons to a mobile computing device that is within a predefined proximity of the transmitter (e.g., within range of the transmitter or within a predefined distance or area next to the transmitter). When the mobile computing device associated with the consumer is located within the predefined proximity of the wireless coupon distribution transmitter, one or more electronic coupons may be automatically selected and distributed to the mobile computing device. For instance, system 100 may identify one or more products that are associated with the wireless coupon distribution transmitter. Such products may include one or more products that are located proximate to the wireless coupon distribution transmitter. System 100 may then search coupon data 114 to identify any electronic coupons associated with the products. System 100 may then select and distribute one or more of electronic coupons to the mobile computing device in any of the ways described herein. Accordingly, as the consumer navigates within the store premises, the consumer may be made aware of one or more electronic coupons that may be used to gain discounts to one or more products that are physically located near the consumer and/or within a particular section of the store premises.

As another example, when the consumer carries the mobile computing device within a geographic proximity of the store premises, such as within the store premises or on a sidewalk or street in front of the store premises, system 100 may identify electronic coupons that have been previously collected by the consumer, identify one or more products associated with the electronic coupons in the consumer's coupon collection, determine whether the products are available for purchase within the store premises, and provide a message to the mobile computing device. The message may be configured to remind the consumer of electronic coupons associated with products that are available for purchase within the store premises. For example, the message may include a list of electronic coupons selected form the consumer's coupon collection that can be redeemed within the store premises. The consumer may select one or more of the electronic coupons from the list and request directions to one or more products associated with the electronic coupon(s). In response, system 100 may provide a message configured to direct the consumer to one or more products within the store premises, as described above.

As another example, as the consumer navigates within the store premises, the consumer may carry the mobile computing device within a geographic proximity of a particular location (e.g., location 1302) within the store premises. In response, system 100 may identify one or more products associated with the location 1302 and search the consumer's coupon collection and/or coupon data 114 for any electronic coupons associated with the products. If a match is found, system 100 may provide a message to the mobile computing device for presentation to the user. The message may be configured to notify the consumer of electronic coupons associated with one or more products that are associated with the location 1302 within the store premises.

In at least one embodiment, the consumer may be able to manually input a product identifier (e.g., input an SKU or scan a barcode of a product) into mobile computing device, and system 100 may respond by searching the consumer's coupon collection and/or coupon data 114 for any electronic coupons associated with the product. If a match is found, system 100 may provide a message to the mobile computing device for presentation to the user. The message may be configured to notify the consumer of electronic coupons associated with the identified product.

As another example, the mobile device may be configured to alert the consumer when the consumer misses a coupon product located within a store premises during a visit to the store premises. For instance, as the consumer navigates within the store premises, the geographic location of the mobile device may be tracked and compared to locations of products located within the store premises and for which the consumer has coupons. If, during the visit to the store premises, the consumer bypasses or otherwise does not visit a location of a product for which the consumer has a coupon, the mobile device may detect this and alert the consumer that he has missed a coupon product. In addition, the mobile device may provide an output configured to guide the consumer to the product. The output may include directions and/or an optimal path from the location of the mobile device to the location of the product within the store premises.

Navigation histories of one or more consumers within a store premises may be utilized to provide helpful output to a consumer. For example, from navigation histories of consumers, system 100 may determine traffic patterns within a store premises. A mobile device associated with a consumer may be configured to access and provide data representative of such traffic patterns. For example, when a consumer is shopping within a store premises, the mobile device may be configured to provide output indicating an existence of a high-density traffic pattern within the store premises. The consumer may utilize the data to enhance his visit to the store premises, such as by deciding to avoid a high traffic area within the store premises or to visit a high traffic area in search of a popular product and/or event (e.g., a sale and/or arrival of a hard-to-find product). In this or a similar manner, navigation history data may be used to inform a consumer of what is happening within the store premises.

As mentioned above, system 100 may be configured to provide navigation history data to one or more marketers for use in making decisions about store layout, product layout, product marketing, etc. based on actual consumer navigation within store premises. As an example, system 100 may utilize a navigation history for one or more consumers within a store premises to generate a store navigation report for the store premises. System 100 may provide the store navigation report to a device 208 associated with a marketer 210 for use by the marketer to adjust a layout of the store premises (e.g., adjust shelf location) and/or a product layout within the store premises (e.g., relocate product within the store premises). For instance, a marketer may ascertain from a store navigation report that a certain location within a store premises has more foot traffic than other locations at a particular time of day. The marketer may use this information strategically, such as by positioning a particular product and/or a particular advertisement at that location at the busy time of the day.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
maintaining coupon data representative of at least one electronic coupon collected by a consumer, the coupon data accessible by a mobile computing device associated with the consumer;
detecting an occurrence of a predetermined trigger event related to the at least one electronic coupon; and
providing, in response to the predetermined trigger event, a message for presentation to the consumer via the mobile computing device associated with the consumer, the message configured to direct the consumer to a physical location of a product associated with the at least one electronic coupon.

2. The method of claim 1, further comprising determining a location of the mobile computing device, wherein the message comprises directions from the location of the mobile computing device to the physical location of the product.

3. The method of claim 2, wherein the directions comprise:
at least one directional arrow indicating at least one direction of travel from the location of the mobile computing device to the physical location of the product; and
an indication of a distance from the location of the mobile computing device to the physical location of the product.

4. The method of claim 2, wherein the directions comprise an indication of an optimal path of travel within a store premises from the location of the mobile computing device to the physical location of the product.

5. The method of claim 4, further comprising displaying, by the mobile computing device, the indication of the optimal path of travel within a map of at least a portion of the store premises.

6. The method of claim 4, further comprising:
tracking a geographic location of the mobile computing device within the store premises over time;
generating a store navigation history of the mobile computing device based on the tracked geographic location of the mobile computing device within the store premises; and
determining the optimal path of travel within the store premises based at least in part on the store navigation history of the mobile computing device.

7. The method of claim 1, wherein the detecting of the occurrence of the predetermined trigger event comprises detecting a receipt, by the mobile computing device, of user input expressly requesting help locating the product associated with the at least one electronic coupon.

8. The method of claim 1, wherein the detecting of the occurrence of the predetermined trigger event comprises detecting a geographic proximity of the mobile computing device to the physical location of the product associated with the at least one electronic coupon.

9. The method of claim 8, wherein the geographic proximity of the mobile computing device to the physical location of the product comprises at least one of:
the mobile computing device being located within a store premises within which the physical location of the product is located;
the mobile computing device being located within range of a wireless signal transmitter positioned at the physical location of the product; and
the mobile computing device being located within a predefined distance of the physical location of the product.

10. The method of claim 8, wherein the detecting of the geographic proximity comprises the mobile computing device receiving a signal from a wireless signal transmitter located at the physical location of the product.

11. The method of claim 8, wherein the detecting of the geographic proximity comprises
comparing geographic position coordinates of the mobile computing device with geographic position coordinates of the physical location of the product, and
determining, based on comparison, that the mobile computing device is located at least one of:
within a store premises in which the physical location of the product is located, and
within a predefined distance of the physical location of the product.

12. The method of claim 1, wherein:
the predetermined trigger event comprises a detected geographic proximity of the mobile computing device to a store premises within which the product associated with the at least one electronic coupon is located; and
the message is configured to remind the consumer of the at least one electronic coupon and notify the consumer of the detected geographic proximity to the store premises within which the product associated with the at least one electronic coupon is located.

13. The method of claim 1, further comprising providing, in response to the predetermined trigger event, an informational video about the product for presentation to the consumer via the mobile computing device.

14. The method of claim 1, embodied as computer-executable instructions on at least one tangible computer-readable medium.

15. A method comprising:
tracking a geographic location of a mobile computing device within a store premises;
generating a store navigation history for a consumer associated with the mobile computing device based on the tracked geographic location of the mobile computing device within the store premises;
detecting an occurrence of a predetermined coupon distribution trigger event;
selecting, in response to the predetermined coupon distribution trigger event, an electronic coupon from a plurality of electronic coupons based at least in part on the store navigation history; and
providing the selected electronic coupon to the consumer.

16. The method of claim 15, wherein the store navigation history comprises data indicative of at least one of:
a preferred day-of-week shopping pattern of the consumer;
a preferred time-of-day shopping pattern of the consumer;
a preferred seasonal shopping pattern of the consumer;
a duration of time spent by the consumer in the store premises; and
a duration of time spent by the consumer in a section within the store premises.

17. The method of claim 15, wherein the selecting of the electronic coupon is further based on a product purchase history of the consumer.

18. The method of claim 15, wherein:
the predetermined coupon distribution trigger event comprises a detected proximity of the mobile computing device to a wireless signal transmitter located at the store premises, the wireless signal transmitter configured to distribute the plurality of electronic coupons; and
the selecting of the electronic coupon from the plurality of electronic coupons and the providing of the selected electronic coupon to the consumer are performed in response to the detected proximity of the mobile computing device to the wireless signal transmitter.

19. The method of claim 15, further comprising:
receiving user input requesting that the selected electronic coupon be saved to a repository of electronic coupons collected by the consumer; and
storing coupon data representative of the selected electronic coupon to the repository of electronic coupons collected by the consumer.

20. The method of claim 19, further comprising:
detecting an occurrence of a predetermined coupon utilization trigger event related to the electronic coupon stored to the repository of electronic coupons collected by the consumer; and
providing, in response to the predetermined coupon utilization trigger event, a message for presentation to the consumer via the mobile computing device associated with the consumer, the message configured to direct the consumer to a physical location of a product associated with the electronic coupon.

21. The method of claim 20, wherein the predetermined coupon utilization trigger event comprises the mobile computing device entering within a store premises within which the physical location of the product associated with the electronic coupon is located.

22. The method of claim 15, further comprising:
utilizing the store navigation history for the consumer to generate a store navigation report for the store premises; and
providing the store navigation report to a device associated with a marketer for use by the marketer to adjust at least one of a layout of the store premises and a product layout within the store premises.

23. The method of claim 15, embodied as computer-executable instructions on at least one tangible computer-readable medium.

24. A system comprising:
a location tracking facility that tracks a geographic location of a mobile phone device within a store premises and generates a store navigation history for a consumer associated with the mobile phone device based on the tracked geographic location of the mobile phone device within the store premises;
a coupon distribution facility that selects an electronic coupon from a plurality of electronic coupons based at least in part on the store navigation history and provides the selected electronic coupon to the consumer;
a coupon collection facility that receives user input requesting that the selected electronic coupon be saved to a repository of electronic coupons collected by the consumer and associates coupon data representative of the selected electronic coupon with the repository of electronic coupons collected by the consumer; and
a coupon utilization facility that detects an occurrence of a predetermined trigger event related to the coupon data and provides, in response to the predetermined trigger event, a message for presentation to the consumer via the mobile phone device associated with the consumer, the message comprising directions from the geographic location of the mobile computing device to the physical location of the product.
